(19) United States
(12) Patent Application Publication
(10) Pub. No.: US 2008/0143558 A1
(43) Pub. Date: Jun. 19, 2008

(54) On-Demand Audio Information System and Method For Air Combat

(75) Inventor: Tsafrir Ben-Ari, Shimshit (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: RAFAEL - ARMAMENT AUTHORITY DEVELOPMENT LTD., Haifa (IL)

(21) Appl. No.: 10/598,985

(22) PCT Filed: Mar. 10, 2005
(86) PCT No.: PCT/IL05/00282

§ 371 Date: Sep. 18, 2007

(30) Foreign Application Priority Data
Mar. 18, 2004 (IL) 160953

(51) Int. Cl. G08B 23/00

(52) U.S. Cl. 340/967; 340/963; 340/969

(57) ABSTRACT

A method for providing on-demand audio information to a pilot of a first aircraft during aerial combat engagement with a hostile aircraft. The method includes receiving a pilot-initiated request for information, identifying the pilot-initiated request as either a first request-type or a second request-type. If the pilot-initiated request is identified as the first request-type, retrieving output information relating to current flight parameters of the first aircraft; if the pilot-initiated request is identified as the second request-type, retrieving output information relating to current flight parameters of the hostile aircraft; and generating a verbal message audible to the pilot containing the output information.

### FIELD AND BACKGROUND OF THE INVENTION

The present invention relates to aircraft and, in particular, it concerns a system and method for providing on-demand audio information for pilots, particularly for fighter aircraft.

A combat aircraft pilot is provided with a plethora of information regarding aircraft systems, current flight parameters, possible airborne or surface targets and/or threats, and corresponding weapon system capabilities. Although certain information can be displayed in a transparent heads-up display (fixed or helmet-mounted), the quantity and type of information which can be displayed without disrupting the pilot's direct view of the environment is extremely limited. As a result, the aforementioned information is generally presented visibly to the pilot via multiple dials, indicator lights, and graphic displays located within the cockpit below the field of view. An experienced pilot familiar with the layout of displays in his aircraft becomes accustomed to quickly assessing the more important information, particularly the current flight parameters and information regarding any urgent threats, by a glance of as little as a second.

The extremely high speed of modern air-to-air combat stretches the capabilities of a human pilot to their limits. Faced with complex aircraft instrumentation and high-tech weapon systems, a pilot is required to achieve split-second reaction times as supersonic aircraft pass each other at relative speeds up to thousands of miles per hour. Despite all the technological tools as his disposal, in a real-time air-to-air combat situation, there is no substitute for direct unaided human vision to maintain overall situational awareness of the relative position and attitude of the aircraft and any hostile threats. In such situations, even the aforementioned quick-glance review of instrumentation may be prohibitively disruptive. For example, when visually following a hostile aircraft which may be barely visible against a bright sky, any deflection of the eyes away from the hostile aircraft, particularly towards the less bright instrumentation, risks complete loss of visual contact. Similarly, during close range maneuvers, the extreme relative speeds of the aircraft render even the shortest diversion of the eyes impossible.

At the same time, the temporary inability to check visually displayed information can itself pose a very serious danger to the pilot. Specifically, during high-speed aerobatic maneuvers, a pilot frequently loses track of basic flight parameters such as speed, altitude and attitude (pitch, roll etc.). Thus, the pilot may feel as though he has pulled out of a loop and be unaware that he is still diving sharply at high speed. In the worst case, this misjudgment may lead to a ground collision. Even where warning systems activate in time to allow the pilot to prevent a crash, the preventative action required of the pilot may be predicted by an aggressor, setting him at a major disadvantage in the ongoing air-to-air combat.

Similarly, when passing a hostile aircraft, it is frequently very difficult to judge the airspeed of the opposing aircraft. Knowledge of the airspeed is vital in assessing the threat posed by the aircraft such as, for example, the ability of the hostile aircraft to turn tightly in order to attack you from behind. The airspeed information is frequently available from the aircraft systems, either from a radar system or via a datalink communication system from other sources. Here too, however, the information is displayed visually on a display which requires a disruptive shift of attention away from the direct visual contact with the hostile aircraft.

Turning now to the use of audio, it is known to provide an audio link audible to the pilot of an aircraft. This audio link is used for a number of specific purposes. These generally fall into one of the following categories:
Voice communication: for example, radio communication between people on different aircraft or platforms;
Feedback indicating the status of a weapon system: for example, an audible tone confirming that a missile activated by the pilot is now tracking a target;
Automatically generated warnings: for example emergency/alarm messages generated under conditions of low fuel, low altitude, systems failure etc.

None of these systems provide a solution for the problem of obtaining essential flight parameters of the aircraft or of a foe during real-time air-to-air combat without the need to look away from the outside environment.

There is therefore a need for a system and method for providing on-demand audio information conveying essential flight parameters of the aircraft or of a foe to a pilot, thereby temporarily reducing the need of the pilot to look towards visual displays within the cockpit.

### SUMMARY OF THE INVENTION

The present invention is a system and method for providing on-demand audio information conveying essential flight parameters of the aircraft or of a foe to a pilot.

According to the teachings of the present invention there is provided, a method for providing on-demand audio information to a pilot of a first aircraft during aerial combat engagement with a hostile aircraft, the method comprising: (a) receiving a pilot-initiated request for information; (b) identifying the pilot-initiated request as either a first request-type or a second request-type; (c) if the pilot-initiated request is identified as the first request-type, retrieving from at least one system of the first aircraft output information relating to current flight parameters of the first aircraft; (d) if the pilot-initiated request is identified as the second request-type, retrieving from at least one system of the first aircraft output information relating to current flight parameters of the hostile aircraft; and (e) generating a verbal message audible to the pilot containing the output information.

According to a further feature of the present invention, the pilot-initiated request is provided by the pilot operating a finger-operated control.

According to a further feature of the present invention, the finger-operated control is located to be operable from a normal hand position while operating at least one of a hand-held flight control and a hand-held weapon control.

According to a further feature of the present invention, the pilot-initiated request is identified as a first request-type or a second request-type according to which of a plurality of the finger-operated controls is operated by the pilot.

According to a further feature of the present invention, the pilot-initiated request is identified as a first request-type or a second request-type according to a time-sequence in which a single finger-operated control is operated by the pilot.

According to a further feature of the present invention, the information relating to current flight parameters of the first aircraft includes at least two current flight parameters chosen from the group comprising: a current speed of the first aircraft; a current altitude of the first aircraft; and a current attitude of the first aircraft.

According to a further feature of the present invention, the information relating to current flight parameters of the first aircraft includes at least: a current speed of the first aircraft; a current altitude of the first aircraft; and a current attitude of the first aircraft.

According to a further feature of the present invention, the information relating to current flight parameters of the hostile aircraft is derived from a radar system of the first aircraft.

According to a further feature of the present invention, the information relating to current flight parameters of the hostile aircraft is retrieved via a data communication system from a source remote from the first aircraft.

According to a further feature of the present invention, the information relating to current flight parameters of the hostile aircraft includes at least a current speed of the hostile aircraft.

According to a further feature of the present invention, the information relating to current flight parameters of the hostile aircraft includes at least: a current speed of the hostile aircraft; and a current aspect angle of the hostile aircraft relative to the first aircraft.

There is also provided according to the teachings of the present invention, a method for providing on-demand audio information to a pilot of an aircraft, the method comprising: (a) receiving a pilot-initiated request for information; (b) retrieving from at least one aircraft system information relating to current flight parameters of the aircraft; and (c) generating a verbal message audible to the pilot containing the information.

According to a further feature of the present invention, the pilot-initiated request is provided by the pilot operating a finger-operated control.

According to a further feature of the present invention, the finger-operated control is located to be operable from a normal hand position while operating at least one of a hand-held flight control and a hand-held weapon control.

According to a further feature of the present invention, the information includes at least two current flight parameters chosen from the group comprising: a current speed of the aircraft; a current altitude of the aircraft; and a current attitude of the aircraft.

According to a further feature of the present invention, the information includes at least: a current speed of the aircraft; a current altitude of the aircraft; and a current attitude of the aircraft.

There is also provided according to the teachings of the present invention, a method for providing on-demand audio information to a pilot of a first aircraft during aerial combat engagement with a hostile aircraft, the method comprising: (a) receiving a pilot-initiated request for information; (b) retrieving from at least one system of the first aircraft information relating to current flight parameters of the hostile aircraft; and (c) generating a verbal message audible to the pilot containing the information.

According to a further feature of the present invention, the pilot-initiated request is provided by the pilot operating a finger-operated control.

According to a further feature of the present invention, the finger-operated control is located to be operable from a normal hand position while operating at least one of a hand-held flight control and a hand-held weapon control.

According to a further feature of the present invention, the information is derived from a radar system of the first aircraft.

According to a further feature of the present invention, the information is retrieved via a data communication system from a source remote from the first aircraft.

According to a further feature of the present invention, the information includes at least a current speed of the hostile aircraft.

According to a further feature of the present invention, the information includes at least: a current speed of the hostile aircraft; and a current aspect angle of the hostile aircraft relative to the first aircraft.

### BRIEF DESCRIPTION OF THE DRAWINGS

The invention is herein described, by way of example only, with reference to the accompanying drawings, wherein:

FIG. 1 is a flow chart illustrating a method according to the present invention for providing on-demand audio information to a pilot;

FIG. 2 is a block diagram of a system constructed and operative according to the teachings of the present invention;

FIGS. 3A and 3B are schematic representations of hand-held flight and weapons controls for use in the system of FIG. 2;

FIG. 4A is a schematic representation of the system and method of the present invention in operation to provide essential flight parameters of the aircraft to a pilot; and

FIG. 4B is a schematic representation of the system and method of the present invention in operation to provide essential flight parameters of a foe to a pilot.

### DESCRIPTION OF THE PREFERRED EMBODIMENTS

The present invention is a system and method for providing on-demand audio information conveying essential flight parameters of the aircraft or of a foe to a pilot.

The principles and operation of systems and methods according to the present invention may be better understood with reference to the drawings and the accompanying description.

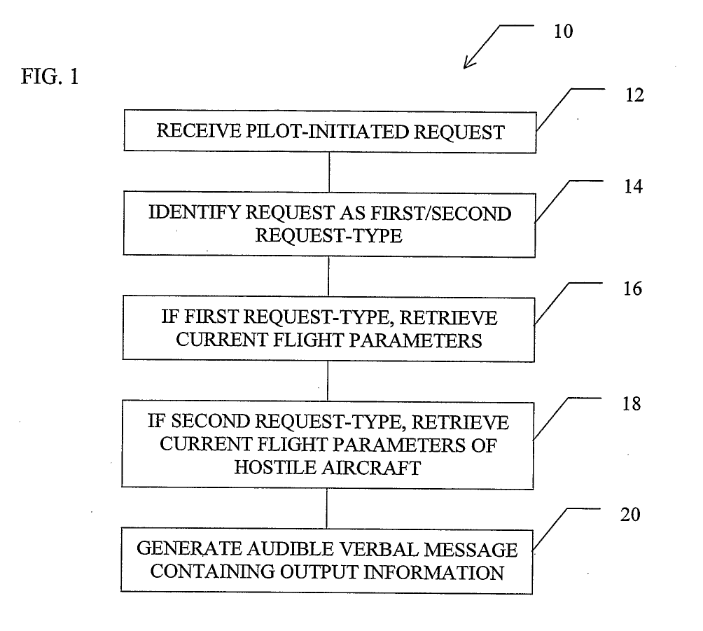

Referring now to the drawings, FIG. 1 illustrates the overall operation of a preferred implementation of a method 10 according to the teachings of the present invention. Generally speaking, method 10 includes receiving a pilot-initiated request for information (step 12) and identifying the request as one of a predefined number request-types (step 14). In the particularly preferred option shown here, two predefined request-types are available. After identifying the type of request, the corresponding requested information is derived from the appropriate aircraft systems or associated sources of information. Thus, in the preferred example illustrated, the first request-type initiates retrieval of current flight parameters for the aircraft flown by the pilot (step 16), while the second request-type initiates retrieval of flight parameters relating to a hostile aircraft designated as the current primary threat/target (step 18). In either case, the requested information is then conveyed audibly to the pilot as a verbal message (step 20).

It will be immediately appreciated that the present invention provides a profound advantage over the prior art systems. Specifically, without in any way modifying the existing visual presentation of information to the pilot, the present invention provides an additional manner for the pilot to update himself with critical information during periods when operational circumstances prohibit a review of visually displayed information. This and other advantages of the present invention will become clearer from the following detailed description.

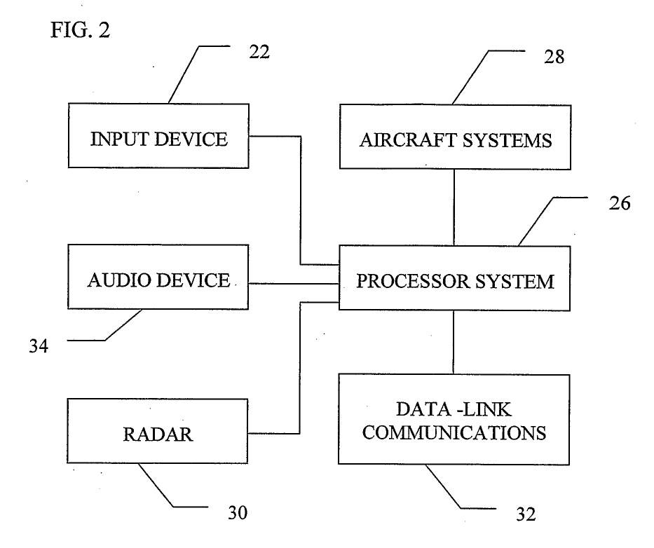

Turning now to FIG. 2, there are shown the primary components of the system of the present invention. Thus, the system includes an input device 22 to allow the pilot to input his request for information, and a processor system 26 for receiving and processing the request. Processor system 26 retrieves the required information in each case from the appropriate on-board or off-board systems. Specifically, in the case of current flight parameters of the aircraft, processor system 26 retrieves the information from the aircraft systems 28, most typically the navigation system. In the case of a request for information regarding a hostile aircraft, information is typically either derived from a radar system 30 or retrieved via a datalink communications system 32 from one or more remote source. Finally, the processor system 26 outputs the information as an audible verbal message via an audio device 34, typically mounted within the pilot's helmet.

It should be noted that the various components of FIG. 2 are functionally defined, but do not necessarily or even typically require any hardware modification of the existing aircraft systems. Thus, processor system 26 is typically a multi-purpose computer already performing various tasks onboard the aircraft to which suitable additional software modules may be added to implement the present invention. Alternatively, processor system 26 may be an additional computer that serves as part of a weapon system such as an air-to-air missile or as part of a launcher electronic unit (LEU), or any other system to which the relevant information is available via the aircraft internal data bus.

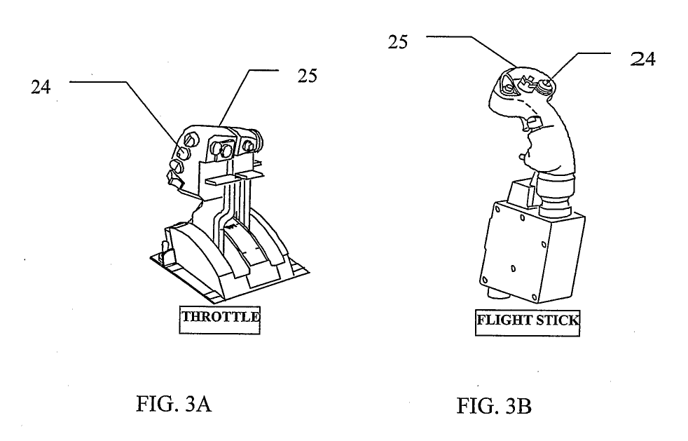

FIGS. 3A and 3B illustrate a further preferred feature of the present invention according to which the input device 22 is a finger-operated control, such as a depressible button 24. Most preferably, the finger-operated control is located so as to be operable from a normal hand position while operating a hand-held flight and/or weapon control 25. It is common for controls such as the throttle of FIG. 3A and the flight-stick of FIG. 3B to have numerous switches and controls as illustrated which are used to control weapon systems and/or other aircraft subsystems. These switches are referred to as “HOTAS switches” (i.e., “Hands On Throttle And Stick switches”), and are arranged to allow operation of the switches without requiring removal of the pilot's hands from the flight controls. The switches often include multifunction or re-allocatable controls which may be used to advantage to implement the present invention with little or no hardware modification of the cockpit systems.

Where more than one type of information request is to be provided, various alternatives exist as to how the different request-types can be distinguished. If sufficient buttons are available, or a multifunction button is available, each request type may advantageously be allocated its own distinct button or button-motion. In many cases, it is preferable to employ a single button allocated to information request functions. The request-type of the pilot-initiated request is then preferably identified according to a time-sequence in which the single finger-operated control is operated by the pilot. Thus, for example, the first request-type may be indicated by a single pressure of the button within a half-second period, while the second request-type may be indicated by two presses of the button within the same period.

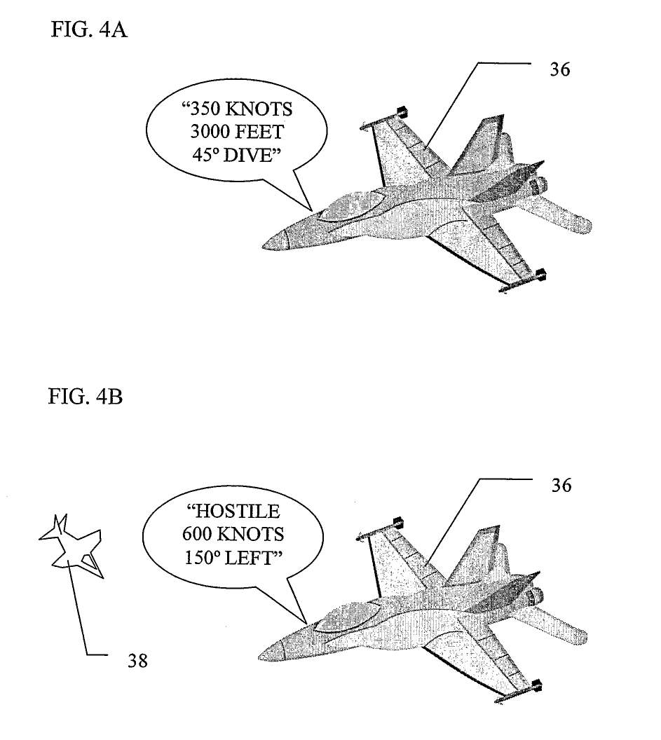

The level of detail of information provided to the pilot according to the present invention may clearly vary considerably. Given the primary function of the invention for high-stress situations, the information is most preferably kept to a minimum while ensuring that the basic parameters essential for safety are included. Practically, the information relating to current flight parameters of the pilot's own aircraft preferably includes at least two, and preferably all three, of: the current speed of the aircraft; the current altitude of the aircraft; and the current attitude of the first aircraft. This is illustrated schematically in FIG. 4A where the pilot is informed that his aircraft 36 is traveling at “350 knots (speed), 3000 feet (altitude), 45° dive (attitude).” These three parameters define the basic relation of the aircraft to the ground to an extent sufficient to avoid.

In the case of information relating to current flight parameters of a hostile aircraft 38, the information preferably includes at least a current speed of the hostile aircraft. Most preferably, it also includes a current aspect angle of the hostile aircraft relative to his own aircraft 36. The “aspect angle” is an indication of the direction of flight of the hostile aircraft relative to the pilot's own aircraft, and is typically defined in terms of the horizontal bearing with 0° being defined as flight straight away from his own aircraft and 180° being directly approaching or “head-on”. Thus, in the example of FIG. 4B, the hostile aircraft 38 is described as “600 knots (speed), 150° left (aspect).” In other words, if the hostile aircraft 38 were to turn an additional 30° left, it would be approaching directly towards aircraft 36. Optionally, additional information derived from any available source such as, for example, the armaments or capabilities of the hostile aircraft, may be added to supplement the basic flight parameters.

It should be noted that, although described herein in the context of a system and method with two request-types, the present invention may be reduced to a single request-type, or expanded to support additional types of information request. In the simplified case, it will be appreciated that the method of FIG. 1 becomes simplified to a three-step method made up of either steps 12, 16 and 20 (own aircraft flight parameters only) or steps 12, 18 and 20 (hostile aircraft information only). Each of these simplified versions of the present invention is believed to be of great utility in its own right.

It will be appreciated that the above descriptions are intended only to serve as examples, and that many other embodiments are possible within the scope of the present invention as defined in the appended claims.

What is claimed is:

1. A method for providing on-demand audio information to a pilot of a first aircraft during aerial combat engagement with a hostile aircraft, the method comprising:
(a) receiving a pilot-initiated request for information;
(b) identifying the pilot-initiated request as either a first request-type or a second request-type;
(c) if the pilot-initiated request is identified as the first request-type, retrieving from at least one system of the first aircraft output information relating to current flight parameters of the first aircraft;
(d) if the pilot-initiated request is identified as the second request-type, retrieving from at least one system of the first aircraft output information relating to current flight parameters of the hostile aircraft; and
(e) generating a verbal message audible to the pilot containing said output information.

2. The method of claim 1, wherein the pilot-initiated request is provided by the pilot operating a finger-operated control.

3. The method of claim 2, wherein said finger-operated control is located to be operable from a normal hand position while operating at least one of a hand-held flight control and a hand-held weapon control.

4. The method of claim 2, wherein the pilot-initiated request is identified as a first request-type or a second request-type according to which of a plurality of said finger-operated controls is operated by the pilot.

5. The method of claim 2, wherein the pilot-initiated request is identified as a first request-type or a second request-type according to a time-sequence in which a single finger-operated control is operated by the pilot.

6. The method of claim 1, wherein the information relating to current flight parameters of the first aircraft includes at least two current flight parameters chosen from the group comprising: a current speed of the first aircraft; a current altitude of the first aircraft; and a current attitude of the first aircraft.

7. The method of claim 1, wherein the information relating to current flight parameters of the first aircraft includes at least: a current speed of the first aircraft; a current altitude of the first aircraft; and a current attitude of the first aircraft.

8. The method of claim 1, wherein the information relating to current flight parameters of the hostile aircraft is derived from a radar system of the first aircraft.

9. The method of claim 1, wherein the information relating to current flight parameters of the hostile aircraft is retrieved via a data communication system from a source remote from the first aircraft.

10. The method of claim 1, wherein the information relating to current flight parameters of the hostile aircraft includes at least a current speed of the hostile aircraft.

11. The method of claim 1, wherein the information relating to current flight parameters of the hostile aircraft includes at least: a current speed of the hostile aircraft; and a current aspect angle of the hostile aircraft relative to the first aircraft.

12. A method for providing on-demand audio information to a pilot of an aircraft, the method comprising:
(a) receiving a pilot-initiated request for information;
(b) retrieving from at least one aircraft system information relating to current flight parameters of the aircraft; and
(c) generating a verbal message audible to the pilot containing said information.

13. The method of claim 12, wherein the pilot-initiated request is provided by the pilot operating a finger-operated control.

14. The method of claim 13, wherein said finger-operated control is located to be operable from a normal hand position while operating at least one of a hand-held flight control and a hand-held weapon control.

15. The method of claim 12, wherein the information includes at least two current flight parameters chosen from the group comprising: a current speed of the aircraft; a current altitude of the aircraft; and a current attitude of the aircraft.

16. The method of claim 12, wherein the information includes at least: a current speed of the aircraft; a current altitude of the aircraft; and a current attitude of the aircraft.

17. A method for providing on-demand audio information to a pilot of a first aircraft during aerial combat engagement with a hostile aircraft, the method comprising:
(a) receiving a pilot-initiated request for information;
(b) retrieving from at least one system of the first aircraft information relating to current flight parameters of the hostile aircraft; and
(c) generating a verbal message audible to the pilot containing said information.

18. The method of claim 17, wherein the pilot-initiated request is provided by the pilot operating a finger-operated control.

19. The method of claim 18, wherein said finger-operated control is located to be operable from a normal hand position while operating at least one of a hand-held flight control and a hand-held weapon control.

20. The method of claim 17, wherein the information is derived from a radar system of the first aircraft.

21. The method of claim 17, wherein the information is retrieved via a data communication system from a source remote from the first aircraft.

22. The method of claim 17, wherein the information includes at least a current speed of the hostile aircraft.

23. The method of claim 17, wherein the information includes at least: a current speed of the hostile aircraft; and a current aspect angle of the hostile aircraft relative to the first aircraft.
